(19) United States
(12) Patent Application Publication
(10) Pub. No.: US 2026/0328904 A1
(43) Pub. Date: Oct. 22, 2026

(54) DETECTING LIVING OBJECTS USING RADAR

(71) Applicant: Texas Instruments Incorporated, Dallas, TX (US)

(72) Inventors: Jayson Paul Van Marter, Richardson, TX (US); Anand Ganesh Dabak, Plano, TX (US); Slobodan Jovanovic, Bethesda, MD (US); Zigang Yang, Dallas, TX (US); Anil Varghese Mani, McKinney, TX (US)

(21) Appl. No.: 19/374,585

(22) Filed: Oct. 30, 2025

Related U.S. Application Data
(60) Provisional application No. 63/792,094, filed on Apr. 21, 2025.
(60) Provisional application No. 63/808,770, filed on May 20, 2025.

(51) Int. Cl. G01S 7/41; G01S 13/58; G01S 13/72

(52) U.S. Cl. CPC G01S 7/415; G01S 7/417; G01S 13/589; G01S 13/723

(57) ABSTRACT

An example apparatus includes: a memory configurable to store radar data across a frame of a plurality of chirps; and processing circuitry coupled to the memory and configurable to: average the radar data across the frame; generate Doppler spectrums for voxels by applying a transform function to the averaged data; and detect a breathing frequency of an object using the Doppler spectrums.

### CROSS-REFERENCE TO RELATED APPLICATION

This patent application claims the benefit of and priority to U.S. Provisional Patent Application No. 63/792,094 filed Apr. 21, 2025, and U.S. Provisional Patent Application No. 63/808,770 filed May 20, 2025, which are hereby incorporated herein by reference in their entirety.

### TECHNICAL FIELD

This description relates generally to radar sensing and, more particularly, to methods and apparatus to detect living objects using radar.

### BACKGROUND

Electronic sensors produce electrical signals representing characteristics of an environment. Radar systems sense objects by transmitting and receiving radio waves. Radar systems use characteristics of reflected waves to determine the location, size, and motion of objects in the environment. Some devices use radar data from reflected waves to accurately detect changes to a surrounding environment, such as object detection, motion tracking, object classification, etc.

### SUMMARY

For detecting living objects using radar, an example device includes a memory configurable to store radar data across a frame of a plurality of chirps. The device includes processing circuitry coupled to the memory and configurable to: average the radar data across the frame, generate doppler spectrums for voxels by applying a transform function to the averaged data, and detect a breathing frequency of an object using the doppler spectrums. Other examples are described.

For detecting living objects using radar, an example system includes a receiver configurable to receive radar signals of a frame having a plurality of chirps. The system includes processing circuitry coupled to the receiver and configurable to: average radar data across the frame, the radar data is representative of the radar signals; generate doppler data for ranges and angles using a transform function and the averaged data; and classifying an object as one of an animate or an inanimate object using the doppler data. Other examples are described.

For detecting living objects using radar, an example method includes obtaining radar data of a plurality of chirps of a frame, the radar data representing an environment. The method includes averaging the radar data across the frame. The method includes generating doppler data for voxels by applying a transform function to the averaged data. The method includes detecting a frequency of motion of an object in the environment using the doppler data. Other examples are described.

### BRIEF DESCRIPTION OF THE DRAWINGS

FIG. 1 is a block diagram of an example vehicle having a radar sensor and target zones.

FIG. 2 is a block diagram of an example radar system including example object classification circuitry.

FIG. 3 is a flowchart representative of example machine-readable instructions or example operations that may be at least one of executed, instantiated, or performed using an example implementation of the object classification circuitry of FIG. 2 or, more generally, the radar system of FIG. 2 in the vehicle of FIG. 1.

FIGS. 4A, 4B, 4C, and 4D are plots of example operations of the object classification circuitry of FIG. 2 during different conditions in the vehicle of FIG. 1.

FIG. 5 is a block diagram of an example of the object classification circuitry of FIG. 2 including an example classification model.

FIGS. 6A, 6B, 6C, 6D, 6E, 6F, 6G, 6H, 6I, and 6J are plots of example operations of the object classification circuitry of FIGS. 2 and 5 during different conditions of the vehicle of FIG. 1.

FIG. 7 is a block diagram of the classification model of FIG. 5.

FIG. 8 is a flowchart representative of example machine-readable instructions or example operations that may be at least one of executed, instantiated, or performed using an example implementation of the object classification circuitry of FIGS. 2 and 5 or, more generally, the radar system of FIG. 2 in the vehicle of FIG. 1.

FIG. 9 is a block diagram of an example processing platform including programmable circuitry structured to execute, instantiate, or perform the example machine-readable instructions or perform the example operations of FIGS. 3 and 8 to implement the object classification circuitry 236 of FIGS. 2 and 5.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Electronic sensors produce electrical signals representing characteristics of an environment. Radar systems sense objects by transmitting and receiving radio waves. Radar systems use characteristics of reflected waves to determine the location, size, and motion of objects in the environment. Some devices use radar data from reflected waves to accurately detect changes to a surrounding environment, such as object detection, motion tracking, object classification, etc.

Some radar systems use 3D range-angle-Doppler estimations to detect object(s) in motion across a plurality of frames. A frame is a sequence of transmitting and receiving waves across a range of frequencies and antennas. In operation, transmitted waves reflect off objects in an environment to produce reflected waves. The radar system represents characteristics of the reflected waves as radar data. The radar data may include range, azimuth, elevation, and/or Doppler shift. The range represents the distance between the radar sensor and the object that reflected the wave. The azimuth is an angle (e.g., a horizontal angle) of the object in relation to the radar sensor. The elevation represents an angle (e.g., a vertical angle) of the object in relation to the radar sensor. The Doppler shift is a change in frequency of the reflected wave, which represents a velocity of the object relative to the radar sensor.

Radar systems use range, azimuth, elevation, and/or Doppler shift across a series of frames to detect changes to the surrounding environment. For example, a radar system uses the Doppler shift represented in the radar data to determine the velocity of an object with a relatively high resolution. These velocities are representative of movements of the object in the environment. Combining the Doppler shift with one or more of the range, azimuth, and/or elevation radar data allows the radar system to localize the motion in the environment.

Further processing of the radar data may be used to perform a wide range of tasks. For example, the radar system uses a model to detect specific types of motion, such as motions associated with vital signs, living objects, periodic portion, etc. If detecting breathing as a vital sign, the radar system applies a model of a breathing signal. The breathing signal model has an amplitude as a function of time (t) and a breathing frequency (f_{b}). Additionally, the breathing signal model has a phase as a function of range (R), angle (A), chest displacement (a_{b}), and a sinusoidal function of time (t) and the breathing frequency (f_{b}). Such phase and amplitude of the breathing signal model are referred to as phase and amplitude data. The radar system can process the breathing model to extract the breathing frequency (f_{b}) from the phase data. The radar system can determine whether an object has vital signs by comparing the breathing frequency (f_{b}) to frequencies associated with living objects. However, in relatively noisy radar environments, such as vehicles, industrial environments, etc., the radar system is prone to false detections.

Examples described herein include methods and apparatus to detect living objects using radar. In some described examples, an example radar system uses a series of radar signals in an environment to classify object(s) as living object(s) (e.g., an animate object, breathing object, periodic motion at certain frequencies, having vital signs, etc.) or as non-living object(s) (e.g., an inanimate object, non-breathing object, lacking vital signs, etc.). Classification can be difficult if a non-living object has a motion rate that is similar to a normal breathing rate of a person because the breathing of a sleeping child is fine motion. In some operations, the radar system uses a breathing model to produce phase and amplitude data at a series of voxels. The radar system generates a frequency spectrum for each voxel from the phase data. The frequency spectrum is a measure of each different signal's contributions to the phase data. The radar system averages the frequency spectrum across a series of reflected waves to produce averaged frequency spectrums. The radar system determines a signal-to-noise ratio (SNR) of a peak in the averaged frequency spectrum across all voxels of the environment. In such operations, the radar system classifies the object at the voxel associated with the peak as living or non-living responsive to comparing the SNR at the peak to a threshold.

In another example, instead of producing frequency spectrums, the radar system uses a doppler fast Fourier transform (FFT) to produce doppler spectrums at different voxels in the environment. The doppler spectrums represent velocities of the voxels across a series of frames. Unlike the frequency spectrum, the doppler spectrums represent motion with a series of peaks and valleys across a range of velocities. The radar system classifies the portion of the environment corresponding to the voxels as having a living or non-living objects by differentiating between patterns associated with different objects. For example, a first doppler spectrum with a series of periodic peaks at different velocities likely corresponds to a living object and a second doppler spectrum with two peaks at different velocities as non-living. Advantageously, using doppler spectrum(s) or SNR at a peak for object classification reduces false detections and increases precision. In addition, the techniques of this disclosure may reduce the number of processing steps as compared to other classification approaches.

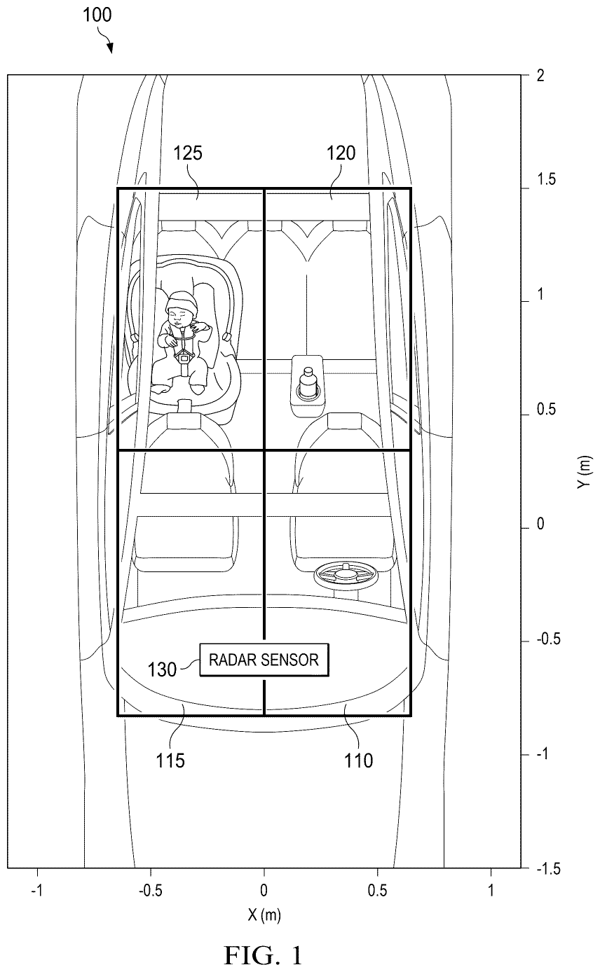

FIG. 1 is a block diagram of an example vehicle 100 having zones 110, 115, 120, 125 and a radar sensor 130. The zones 110, 115, 120, 125 span the in-cabin portions of the vehicle 100. In some examples, the locations of the zones 110, 115, 120, 125 are in portions of the vehicle 100 that are likely occupied. For example, the zone 110 encloses a driver seat and a front driver side portion of the vehicle 100, the zone 115 encloses a passenger seat and a front passenger side portion of the vehicle 100, the zone 120 encloses a back driver side portion of the vehicle 100, and the zone 125 encloses a back passenger side portion of the vehicle 100. Advantageously, radar data associated with the zones 110, 115, 120, 125 changes with the condition of the vehicle 100 or an occupancy of the vehicle 100. Advantageously, as further described herein, a radar system can use the radar sensor 130 to detect a living object, such as a baby, passenger, etc., in one of the zones 110, 115, 120, 125. Although this disclosure describes the example of detecting a child inside a vehicle (e.g., in-cabin radar), the techniques of this disclosure can be used in a variety of systems. For example, personal electronics, smart home devices, robotics, building automation, surveillance, security, medical devices, baby monitors, in-home patient monitors, and the like may be configured to implement the techniques of this disclosure.

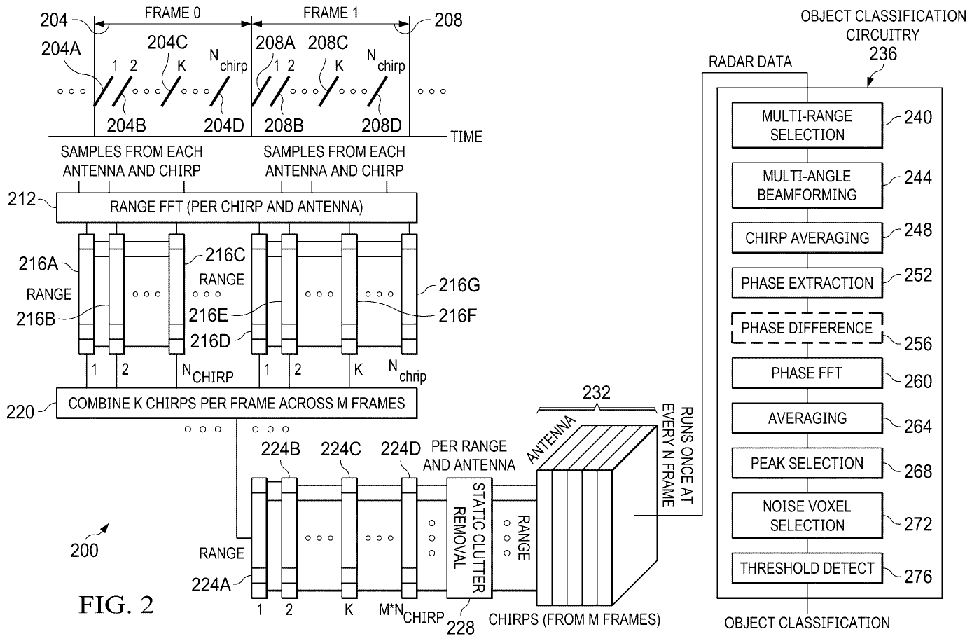

FIG. 2 is a block diagram of an example radar system 200 which uses an in-cabin vehicle radar, such as the radar sensor 130, for detecting living objects in the vehicle 100. In the example of FIG. 2, the radar system 200 includes a first example frame 204, a second example frame 204, example range FFT circuitry 212, example range data 216A-G, example combination circuitry 220, example combined range data 224A-224D, example clutter removal circuitry 228, example range data array 232, and example object classification circuitry 236.

The frames 204, 208 (FRAME 0, FRAME 1) represent a sequence of operations of the radar system 200 to produce radar data. During the frames 204, 208, the radar sensor 130 transmits radio wave(s) across a range of frequencies. In some examples, a radio wave of a specific frequency is referred to as a chirp. During the frames 204, 208, the radar system 200 produces N number of example chirps 204A-204D, 208A-208D spanning a range of frequencies.

The range FFT circuitry 212 converts received signals from a time domain to a frequency domain. In some examples, the range FFT circuitry 212 is a part of an analog frontend circuit, which sequences the transmission and reception of the radar signals as a way of obtaining radar data of received waves. The range FFT circuitry 212 produces the range data 216A-216G by converting received waves into the frequency domain. The range data 216A-216G represents distances of objects across the chirps of the frames 204, 208, which is referred to as range. In some examples, the range FFT circuitry 212 stores the range data 216A-216G for a plurality of antennas of the radar system 200.

The combination circuitry 220 produces the combined range data 224A-224D by combining the range data 216A-216G by frame, such as combining corresponding chirps of the frames 204, 208. For example, if the frames 204, 208 have chirps corresponding to the same frequencies in the same environment, the combination circuitry 220 combines the range data 216A-216G to produce the combined range data 224A-224D. In some examples, the combination circuitry 220 combines range data across chirps, antennas, a reference number of frames (M). For example, if the frames 204, 208 have N number of chirps and the combination circuitry 220 combines M number of frames, the combined range data 224A-224D includes K number of chirps representing N number of chirps across M number of frames. In such examples, the combination circuitry 220 waits for the radar sensor 130 to sweep N number of chirps for M number of frames to form the combined range data 224A-224D.

The clutter removal circuitry 228 removes static data of the range data 224A-224D. In some examples, the clutter removal circuitry 228 filters out zero dopplers to remove static voxels from the range data 224A-224D. In such examples, the clutter removal circuitry 228 performs a doppler FFT to convert the range data 224A-224D to doppler vectors. In other examples, the clutter removal circuitry 228 averages the range data 224A-224D for each combined chirp. In such examples, the clutter removal circuitry 228 removes static range data by subtracting the average for the chirp from the range data 224A-224D. The clutter removal circuitry 228 generates the range data array 232 to store the filtered range data by chirp and antenna. In such examples, the range data array is a multi-dimensional array of the filtered range data.

The object classification circuitry 236 is coupled to the range data array 232. The example object classification circuitry 236 of FIG. 2 includes example multi-range selection circuitry 240, example multi-angle beamforming circuitry 244, example chirp averaging circuitry 248, example phase extraction circuitry 252, example phase difference circuitry 256, example phase FFT circuitry 260, example averaging circuitry 264, example peak selection circuitry 268, example noise voxel selection circuitry 272, and example threshold detection circuitry 276. The object classification circuitry 236 receives the range data array 232 as radar data. The object classification circuitry 236 classifies zones, such as the zones 110, 115, 120, 125, as having an animate or inanimate object using the radar data.

In example operations, the multi-range selection circuitry 240 selects a subset of the range data array 232 to process. In some examples, the multi-range selection circuitry 240 identifies ranges of the range data array 232 as ranges of interest. In such examples, the multi-range selection circuitry 240 divides the range data array 232 into subsets based on a possible corresponding one of the zones 110, 115, 120, 125. For example, the multi-range selection circuitry 240 identifies voxels of the range data array 232 for ranges of a given one of the zones 110, 115, 120, 125. In other examples, the object classification circuitry 236 uses an azimuth to identify radar data corresponding to a zone or area of interest.

The multi-angle beamforming circuitry 244 processes the portions of the range data array 232 that the multi-range selection circuitry 240 identifies. In some examples, the multi-angle beamforming circuitry 244 uses beamforming to combine values of the identified range data for different angles. Beamforming is a series of operations to process radar data for a voxel. A voxel represents an object at a given location, such as a fixed point at different ranges and angles across antennas. As used herein, a voxel represents a range (R) and angle (θ) in relation to the radar sensor 130. The multi-angle beamforming circuitry 244 produces radar data representing the voxel across different antennas. For example, if the radar sensor 130 has thirty-two antennas, the multi-angle beamforming circuitry 244 logically combines reflections from an object at a given voxel across a plurality of antennas. In such examples, the multi-angle beamforming circuitry 244 accounts for each antenna having a different angle in relation to the location in space of a voxel. The multi-angle beamforming circuitry 244 produces radar data for a series of voxels (R, θ) across different chirps (C) and frames (F).

The chirp averaging circuitry 248 averages and/or sums the radar data of the voxels across different chirps of each of the frames (e.g., a time-based average). In some examples, if each frame has N number of chirps, the chirp averaging circuitry 248 identifies which chirps correspond to each frame. In such examples, the chirp averaging circuitry 248 averages the radar data of each voxel across each frame of the chirp. The chirp averaging circuitry 248 produces radar data for the voxels (R, θ) across different frames (F).

The phase extraction circuitry 252 determines a phase of signals of the radar data for the voxels across frames. The phase extraction circuitry 252 represents measured breathing signals of a breathing model (y(t)) using Equation (1). In some examples, Equation (1) represents breathing in as a signal (y(t)) using amplitude data (B(f_{b}t)) and phase data (j2π(R+A+a_{b} sin(2πf_{b}t))). The amplitude data represents a function of a breathing frequency (f_{b}) and time (t). The phase data represents a function of range to a target (R), angle to the target (A), displacement of chest (a_{b}), the breathing frequency (f_{b}), and time (t). Typically, living objects breathe at a relatively steady frequency that usually does not change at relatively high frequencies. Accordingly, the phase extraction circuitry 252 separates the phase of the reflected signal (y(t)) from the amplitude. The phase extraction circuitry 252 produces phases for the voxels (R, θ) across different frames (F).

$$y ( t ) = B ( {f}_{b} t ) * exp \{ j 2 π ( R + A + {a}_{b} sin ( 2 π {f}_{b} t ) ) \} \qquad Equation ( 1 )$$

In some examples, the radar system 200 uses complex signals to represent the amplitude and phase data. For example, the radar system 200 generates complex signals having real and imaginary parts representative of the amplitude and phase of portions of the radar data. In another example, the radar system 200 uses magnitudes to represent amplitude and/or phase of a signal at a specific frequency. For example, the radar system 200 represents the radar data using a series of magnitudes for different phases and frequencies.

The phase difference circuitry 256 determines the difference between phases for the voxels across the different frames. In some examples, the phase difference circuitry 256 removes constants across the phase of the voxels. For example, if using Equation (1) to model breathing, the phase difference circuitry 256 the range to a target (R), angle to the target (A), and displacement of chest (a_{b}) are constant across phases of each voxel. In such examples, the phase difference circuitry 256 removes the range to a target (R), angle to the target (A), and displacement of chest (a_{b}) from the phases for the voxels across different frames. The phase difference circuitry 256 produces phases as a sinusoidal function for voxels across frames. Such sinusoidal functions may be referred to as a breathing sinusoid.

The phase FFT circuitry 260 performs a transform function, such as an FFT, on the breathing sinusoids of the voxels. In some examples, the phase FFT circuitry 260 determines frequencies of motion at the voxels. In such examples, the phase FFT circuitry 260 produces a frequency spectrum using an FFT. The frequency spectrum represents contributions to the phase of a voxel for a range of frequencies. The phase FFT circuitry 260 produces frequency spectrums for the voxels (R, θ). In some examples, the radar system 200 uses multi-frame time gating to set a fixed time between frames. In such examples, setting the time between frames to a fixed interval increases the accuracy of the FFT by evenly timing frames. The phase FFT circuitry 260 produces a frequency spectrum for each voxel. The frequency spectrum represents contributions of signals across a range of frequencies.

The averaging circuitry 264 averages frequency spectrums of the voxels across a plurality of measurements. In some examples, the averaging circuitry 264 associates a frequency spectrum with a specific voxel (angle and range). In such examples, the averaging circuitry 264 averages frequency spectrum associated with the same voxel across P number of measurements. For example, if the range data array 232 contains M number of frames, the phase FFT circuitry 260 produces a frequency spectrum every M number of frames. In such examples, the averaging circuitry 264 generates an average frequency spectrum after the range data array 232 has been determined P number of times. The averaging circuitry 264 produces an averaged frequency spectrum for each of the voxels.

The peak selection circuitry 268 determines a peak (e.g., a maximum amplitude) in the averaged frequency spectrums across the voxels. In some examples, the peak selection circuitry 268 checks for local peaks in a bandwidth of frequencies corresponding to potential vital signs, such as breathing. For example, the peak selection circuitry 268 looks for a peak at frequencies less than five hertz (Hz). In such examples, the peak selection circuitry 268 determines the peak to be a frequency with the largest contributions across the voxels within the searched bandwidth. The peak selection circuitry 268 provides the peak and the averaged frequency spectrums.

The noise voxel selection circuitry 272 generates a signal to noise ratio (SNR) for the determined peak. In some examples, the noise voxel selection circuitry 272 uses an average noise value to generate the SNR of the peak. The average noise value is an average of frequencies near the frequency of the peak across voxels. For example, if the peak is at one hertz (Hz) and corresponds to a first voxel, the noise voxel selection circuitry 272 averages the contributions at three-quarters hertz and five-quarters hertz across all voxels to determine the average noise value. In such examples, the noise voxel selection circuitry 272 generates the SNR of the peak by dividing the amplitude of the peak by the determined noise value. The noise voxel selection circuitry 272 provides the SNR as a representation of the strength of the peak.

The threshold detection circuitry 276 compares the SNR of the peak to a threshold value. If the threshold detection circuitry 276 determines the SNR of the peak is greater than the threshold value, the threshold detection circuitry 276 determines the peak corresponds to vital signs, such as breathing. If the threshold detection circuitry 276 determines the SNR of the peak is less than the threshold value, the threshold detection circuitry 276 determines the peak does not correspond to vital signs. In some examples, upon detecting vital signs at the peak, the threshold detection circuitry 276 classifies an object at the corresponding voxel as living.

Accordingly, the object classification of the threshold detection circuitry 276 may be used to perform a series of safety operations. For example, when a living object is detected only in zone 125 (e.g., the back seat), the vehicle 100 can alert a user. Advantageously, the object classification circuitry 236 detects living objects by detecting objects that have motion in frequencies corresponding to vital signs, such as breathing, heart rate, etc. Example operations of the object classification circuitry 236 are further illustrated and described in connection with FIG. 3.

FIG. 3 is a flowchart representative of example machine-readable instructions or example operations 300 that may be at least one of executed, instantiated, or performed using an example implementation of the object classification circuitry 236 of FIG. 2 or, more generally, the radar system 200 of FIG. 2 in the vehicle 100 of FIG. 1. The example operations 300 begin at Block 305, at which the radar sensor 130 receives radar signals of a plurality of chirps and frames for an environment. In example operation, the radar sensor 130 transmits a series of signals at different frequencies and antennas into an environment, such as the vehicle 100. The radar sensor 130 receives the chirps 204A-204D as objects of the environment reflect the signals. The chirps 204A-204D form the frame 204 as radar data capturing objects of an environment at a first time. In some examples, after a fixed interval of time, the radar sensor 130 transmits another series of signals to capture additional radar data of the environment at a subsequent time. In such examples, the fixed interval of time between the frames 204, 208 provides the radar system 200 time to process the radar data of the frame 204 and prevent uneven timing between frames. Such a method of using fixed intervals between frames is referred to as multi-frame time gating, where the chirp sample spacing may be uniform. Advantageously, multi-frame time gating allows the radar system 200 to perform an FFT across multiple frames using at least one chirp sample per frame.

The range FFT circuitry 212 transforms the radar signals to radar data having ranges. (Block 310). In example operation, the range FFT circuitry 212 converts received signals from a time domain to a frequency domain. For example, the range FFT circuitry 212 produces the range data 216A-216G by converting the chirps 204A-204D as received by different antennas into the frequency domain. The range data 216A-216G represents distances of objects across antennas of the radar sensor 130 for the frame 204, which is referred to as range.

In some examples, as indicated by the dashed outline, the clutter removal circuitry 228 filters static radar data. (Block 315). In example operation, the clutter removal circuitry 228 reduces the size and complexity of the combined range data 224A-224D by filtering chirps corresponding to a stationary object. For example, the clutter removal circuitry 228 removes data having a zero doppler value. A doppler value is a measure of the movement of an object across the frames 204, 208. In other examples, the clutter removal circuitry 228 filters the combined range data 224A-224D by removing an average value across a chirp. In both examples, the clutter removal circuitry 228 reduces the processing complexity by reducing the size of the range data array 232.

The multi-range selection circuitry 240 selects ranges of the radar data. (Block 320). In example operation, the multi-range selection circuitry 240 selects a subset of the range data array 232 to process. In some examples, the multi-range selection circuitry 240 identifies ranges of the range data array 232 as ranges of interest. In other examples, the object classification circuitry 236 uses an azimuth to identify radar data corresponding to a zone or area of interest.

The multi-angle beamforming circuitry 244 performs angle beamforming for the selected ranges of the radar data. (Block 325). In example operation, the multi-angle beamforming circuitry 244 uses beamforming to combine values of the identified range data for different angles. The multi-angle beamforming circuitry 244 produces radar data representing the voxel across different antennas. The multi-angle beamforming circuitry 244 produces radar data for a series of voxels (R, θ) across different chirps (C) and frames (F).

The phase extraction circuitry 252 extracts phases from the radar data. (Block 330). In example operation, the phase extraction circuitry 252 determines a phase of signals of the radar data for the voxels across frames. The phase extraction circuitry 252 represents vital signals, such as breathing, of reflected signals (y(t)) using Equation (1). In some examples, Equation (1) represents breathing in the reflected signal (y(t)) using an amplitude (B(f_{b}t)) and a phase (j2π(R+A+a_{b} sin(2πf_{b}t))). In such example operations, the phase extraction circuitry 252 separates the phase of the reflected signal (y(t)) from the amplitude. The phase extraction circuitry 252 produces phases for the voxels (R, θ) across different frames (F).

In some examples, as indicated by the dashed outline, the phase difference circuitry 256 determines phase differences of the radar data. (Block 335). In example operation, the phase difference circuitry 256 removes constants across the phase of the voxels. For example, if using Equation (1) to represent breathing, the phase difference circuitry 256 removes the range to a target (R), angle to the target (A), and displacement of chest (a_{b}) as constants from the phases for the voxels across different frames. The phase difference circuitry 256 produces phases as a sinusoidal function for voxels across frames.

The phase FFT circuitry 260 transforms the radar data to determine frequency components of the radar data. (Block 340). In example operation, phase FFT circuitry 260 performs an FFT on the phased of the voxels across the frames. The phase FFT circuitry 260 produces a frequency spectrum for each of the voxels (R, θ). The frequency spectrums represent signal contributions at the voxels (R, θ) by frequency.

The averaging circuitry 264 averages amplitudes of the frequency data across the frames of the radar data. (Block 345). In example operation, the averaging circuitry 264 averages frequency spectrums of a given voxel (e.g., data at of an angle and range). In some examples, the averaging circuitry 264 averages frequency spectrums associated with the same voxel across P number of sets of the range data array 232. For example, the averaging circuitry 264 generates an average frequency spectrum after the range data array 232 has been determined P number of times. The averaging circuitry 264 produces average radar data or, more generally, averaged data representing frequency spectrum for each of the voxels.

The peak selection circuitry 268 determines a peak frequency of the average radar data. (Block 350). In example operation, the peak selection circuitry 268 determines a peak in the averaged frequency spectrums. In some examples, the peak selection circuitry 268 determines the peak to be a frequency with the largest contributions across the voxels within a range of frequencies.

The noise voxel selection circuitry 272 determines an average amplitude of the peak across voxels of the radar data. (Block 355). In example operation, the noise voxel selection circuitry 272 determines an average noise value as an average of frequencies near the frequency of the peak across voxels. For example, if the peak is at one hertz (Hz) and corresponds to a first voxel, the noise voxel selection circuitry 272 averages the contributions at three-quarters hertz and five-quarters hertz across all voxels to determine the average noise value.

The noise voxel selection circuitry 272 determines a signal strength using maximum and averaged amplitudes at the peak frequency. (Block 360). In example operation, the noise voxel selection circuitry 272 generates an SNR for the determined peak using the average noise value. In such examples, the noise voxel selection circuitry 272 generates the SNR of the peak by dividing the amplitude of the peak by the determined noise value.

The threshold detection circuitry 276 determines if the signal strength is greater than a threshold. (Block 365). In example operations, the threshold detection circuitry 276 compares the SNR of the peak to a threshold value. In some examples, the threshold value represents a difference between the frequency of the peak and the surrounding frequencies to identify a vital sign, such as breathing or a heartbeat.

If the threshold detection circuitry 276 determines that the signal strength is not greater than a threshold (e.g., Block 365 returns a result of NO), the threshold detection circuitry 276 classifies the environment as not having a living object. (Block 370). In example operation, if the threshold detection circuitry 276 determines the SNR of the peak is less than the threshold value, the threshold detection circuitry 276 determines the peak does not correspond to vital signs. In some examples, upon failing to detect vital signs at the peak, the threshold detection circuitry 276 classifies an object at the corresponding voxel as inanimate or non-living.

If the threshold detection circuitry 276 determines that the signal strength is greater than a threshold (e.g., Block 365 returns a result of YES), the threshold detection circuitry 276 classifies the environment has having a living object. (Block 375). In example operation, if the threshold detection circuitry 276 determines the SNR of the peak is greater than the threshold value, the threshold detection circuitry 276 determines the peak corresponds to vital signs, such as breathing. In some examples, upon detecting vital signs at the peak, the threshold detection circuitry 276 classifies an object at the corresponding voxel as animate or living.

Control proceeds to end. Although example methods are described with reference to the flowchart illustrated in FIG. 3, many other methods of implementing the object classification circuitry 236 of FIG. 2 or, more generally, the radar system 200 of FIG. 2 may alternatively be used in this description. For example, the order of execution of the blocks may be changed, and/or some of the blocks described may be changed, eliminated, or combined. Similarly, additional operations may be included in the manufacturing process before, in between, or after the blocks shown in the illustrated examples.

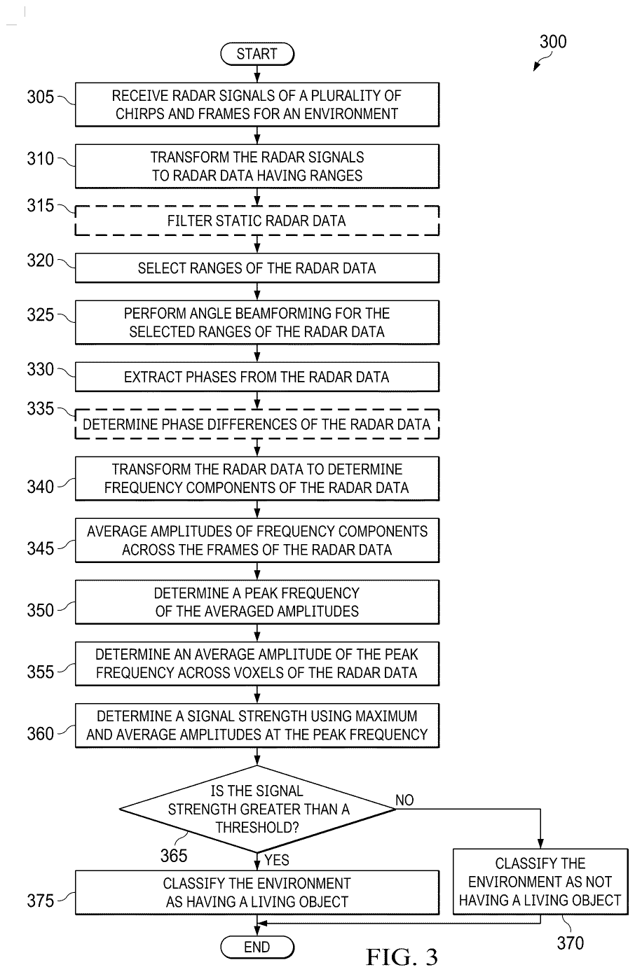

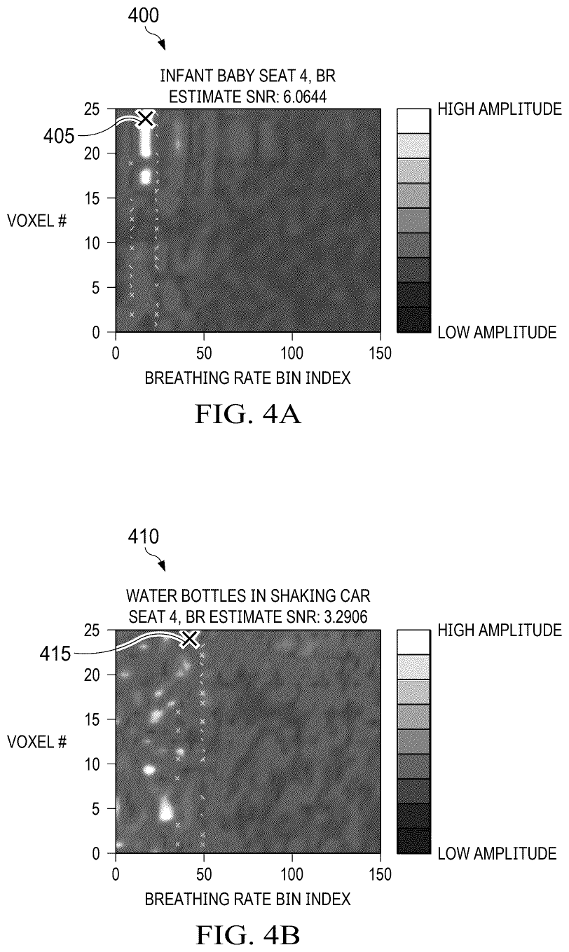

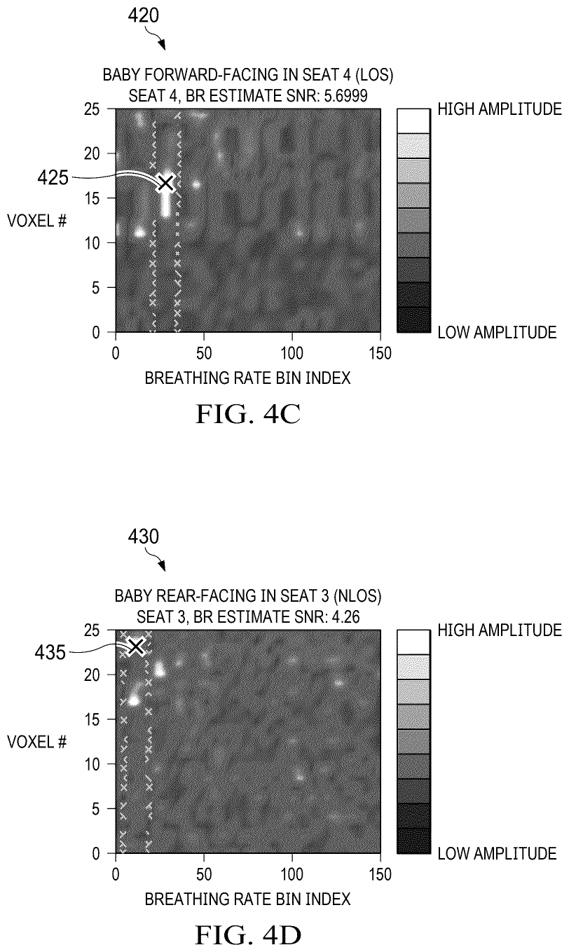

FIG. 4A is a plot 400 of example operations of the object classification circuitry 236 of FIG. 2 during a condition where a baby is in the zone 125 of the vehicle 100. In the example of FIG. 4A, the plot 400 illustrates frequency spectrums for different voxels in in the zone 125 of the vehicle 100. The illustrated frequency spectrums of the plot 400 illustrate signal contributions at different breathing rates instead of frequency. In practice, a living object is likely to have a resting breathing rate less than 60 breaths per minute. Thus, the peak selection circuitry 268 or, more generally, the object classification circuitry 236 may select a local peak that has a frequency corresponding to a breathing rate under 60 breaths per minute (e.g., breathing rate bin 60 or lower).

In example operations of FIG. 4A, the peak selection circuitry 268 detects a peak 405 at a breathing rate of approximately 16 breaths per minute. After determining the peak 405, the noise voxel selection circuitry 272 averages amplitudes at breathing rates of approximately 12 and 20 breaths per minute across the voxels of the plot 400. Such points to be averaged are illustrated in FIG. 4A by an “x.” The noise voxel selection circuitry 272 uses the amplitude at the peak 405 and the average noise to produce an SNR of approximately six. After determining the SNR, the threshold detection circuitry 276 compares the SNR to a threshold value. As long as the threshold value is less than six, the object classification circuitry 236 accurately classifies the object at the twenty-fourth voxel as living or animate.

FIG. 4B is a plot 410 of example operations of the object classification circuitry 236 of FIG. 2 during a condition where a water bottle is in the zone 125 and the vehicle 100 is shaking, such as when the engine is running. In the example of FIG. 45, the plot 410 illustrates frequency spectrums for different voxels in the zone 125 when the vehicle 100 is shaking. Additional example details of detecting objects in shaking environments can be found in commonly assigned U.S. Patent Application Publication No. 2025/0306195, entitled “Occupancy Detection Using Radar,” filed Mar. 13, 2025, which is incorporated by reference in its entirety.

In example operations of FIG. 4B, the peak selection circuitry 268 detects a peak 415 at a breathing rate of approximately 42 breaths per minute. After determining the peak 415, the noise voxel selection circuitry 272 averages amplitudes at breathing rates of approximately 38 and 46 breaths per minute across the voxels of the plot 410. Such points to be averaged are illustrated in FIG. 4B by an “x.” The noise voxel selection circuitry 272 uses the amplitude at the peak 415 and the average noise to produce an SNR of approximately three and three-tenths. After determining the SNR, the threshold detection circuitry 276 compares the SNR to a threshold value. As long as the threshold value is greater than three and three-tenths, the object classification circuitry 236 accurately classifies the water bottle, which is shaking with the vehicle 100, the twenty-fourth voxel as non-living or inanimate. Similarly, setting the threshold value between six and three and three-tenths allows the object classification circuitry 236 to accurate differentiate between the conditions of FIGS. 4A and 4B. By measuring the breathing signal at multiple voxels (to create a breathing signal spectrum), object classification circuitry 236 can search for the breathing signal and create locations for taking a noise level estimation.

FIG. 4C is a plot 420 of example operations of the object classification circuitry 236 of FIG. 2 during a condition where the radar sensor 130 has a direct line of sight (LOS) with a baby in the vehicle 100. For example, the baby is facing the radar sensor 130 and has an unobstructed view of the radar sensor 130. In the example of FIG. 4C, the plot 420 illustrates frequency spectrums for different voxels in the zone 125 of the vehicle 100.

In example operations of FIG. 4C, the peak selection circuitry 268 detects a peak 425 at a breathing rate of approximately 28 breaths per minute. After determining the peak 425, the noise voxel selection circuitry 272 averages amplitudes at breathing rates of approximately 24 and 32 breaths per minute across the voxels of the plot 420. Such points to be averaged are illustrated in FIG. 4C by an “x.” The noise voxel selection circuitry 272 uses the amplitude at the peak 425 and the average noise to produce an SNR of approximately five and seven-tenths. After determining the SNR, the threshold detection circuitry 276 compares the SNR to a threshold value. As long as the threshold value is less than five and seven-tenths, the object classification circuitry 236 accurately classifies the object at the eighteenth voxel as living or animate. Similarly, setting the threshold value between five and seven-tenths and three and three-tenths allows the object classification circuitry 236 to accurately detect objects across the conditions of FIGS. 4A, 4B, and 4C.

FIG. 4D is a plot 430 of example operations of the object classification circuitry 236 of FIG. 2 during a condition where the radar sensor 130 has a non-direct line of sight (NLOS) with a baby in the vehicle 100. For example, the radar sensor 130 has an obstructed view of the baby. In the example of FIG. 4D, the plot 430 illustrates frequency spectrums for different voxels in the zone 120 of the vehicle 100.

In example operations of FIG. 4D, the peak selection circuitry 268 detects a peak 435 at a breathing rate of approximately 12 breaths per minute. After determining the peak 435, the noise voxel selection circuitry 272 averages amplitudes at breathing rates of approximately 8 and 16 breaths per minute across the voxels of the plot 430. Such points to be averaged are illustrated in FIG. 4D by an “x.” The noise voxel selection circuitry 272 uses the amplitude at the peak 435 and the average noise to produce an SNR of approximately four and three-tenths. After determining the SNR, the threshold detection circuitry 276 compares the SNR to a threshold value. As long as the threshold value is less than four and three-tenths, the object classification circuitry 236 accurately classifies the object at the twenty-third voxel as living or animate. Similarly, setting the threshold value between four and two-tenths and three and three-tenths allows the object classification circuitry 236 to accurately detect objects across the conditions of FIGS. 4A, 4B, 4C, and 4D.

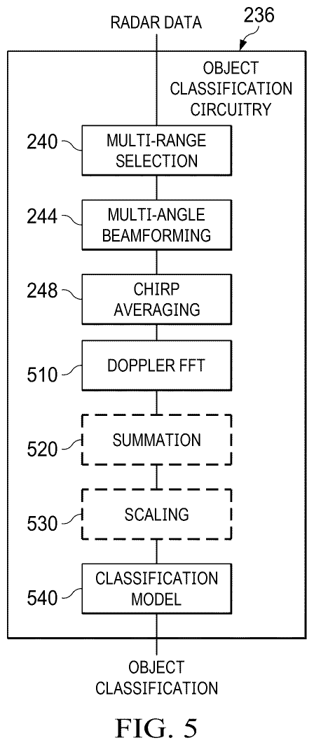

FIG. 5 is a block diagram of another example of the object classification circuitry 236 of FIG. 2. The example object classification circuitry 236 of FIG. 5 includes the multi-range selection circuitry 240, the multi-angle beamforming circuitry 244, the chirp averaging circuitry 248, doppler FFT circuitry 510, summation circuitry 520, scaling circuitry 530, and a classification model 540. Unlike the object classification circuitry 236 of FIG. 2, in FIG. 5, the object classification circuitry 236 uses both the phase and magnitude components of Equation (1) to detect vital signs.

In example operations of FIG. 5, the chirp averaging circuitry 248 provides average radar data for the voxels (R, θ) across different frames (F) to the doppler FFT circuitry 510. The doppler FFT circuitry 510 performs a transform function, such as a doppler FFT, on the radar data of the voxels across the different frames (F). Unlike the FFT of the phase FFT circuitry 260, the doppler FFT of the doppler FFT circuitry 510 produces doppler data (also referred to as doppler spectrum(s)) representing velocities of voxels across the frames. For example, voxels with zero velocity, such as voxels on a stationary object, have a zero doppler value. In such examples, voxels with a non-zero velocity, such as voxels on a moving object have a positive doppler value. The doppler FFT circuitry 510 produces doppler spectrums for the voxels (R, θ). The doppler FFT circuitry 510 produces a doppler spectrum for each voxel. In such examples, the doppler FFT circuitry 510 provides a multi-dimensional doppler data (also referred to as multi-dimensional doppler spectrum) having the doppler spectrums of across voxels. The resulting FFT may be a Bessel function due it being an exponential of a sinusoid, without considering the amplitude dependence on the breathing. The Bessel function may result from taking an FFT of a complex signal to generate the doppler spectrum.

The summation circuitry 520 combines the multi-dimensional doppler data across the voxels. In some examples, the summation circuitry 520 produces one-dimensional doppler data representing the different velocities of objects across the frames of the range data array 232. In such examples, the 1D doppler data is a one-dimensional doppler spectrum representing a function of both magnitude and phase of vital signs. The summation circuitry 520 provides the 1D doppler spectrum as a representation of motion in the environment.

The scaling circuitry 530 scales the doppler spectrum. In some examples, the scaling circuitry 530 scales values of the doppler spectrum to improve resolution or shift values from relatively large or small values. In such examples, scaling the doppler values reduces complexity by decreasing the data size of the doppler values.

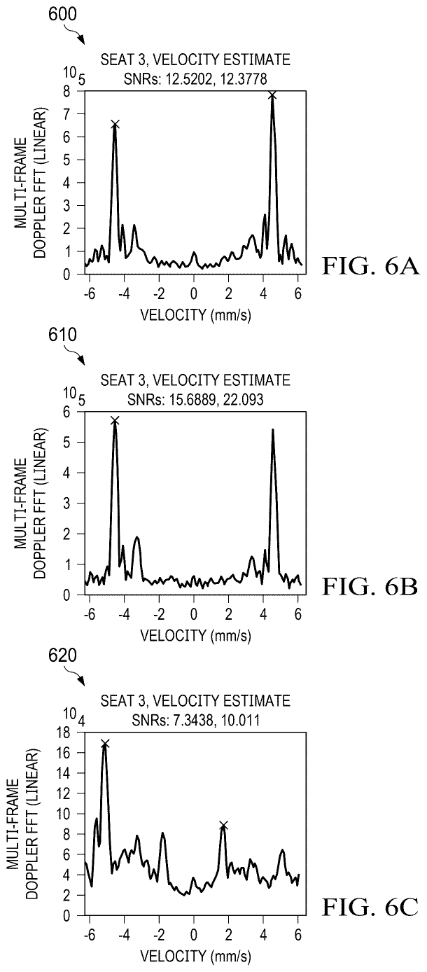

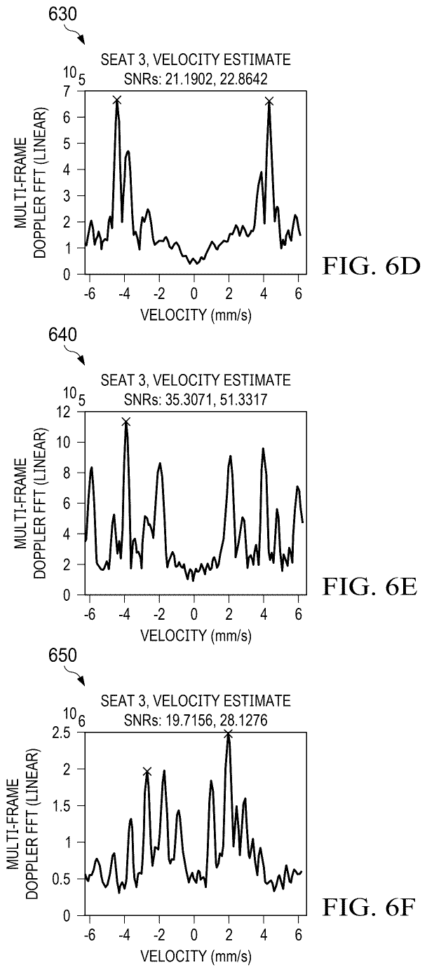

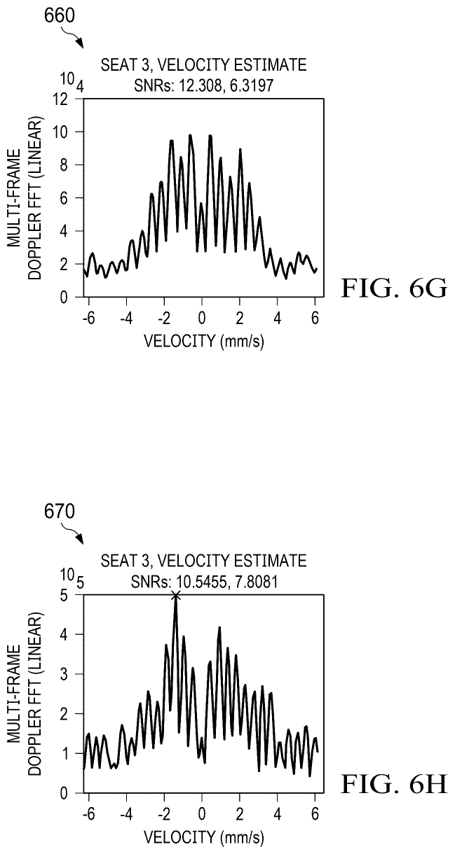

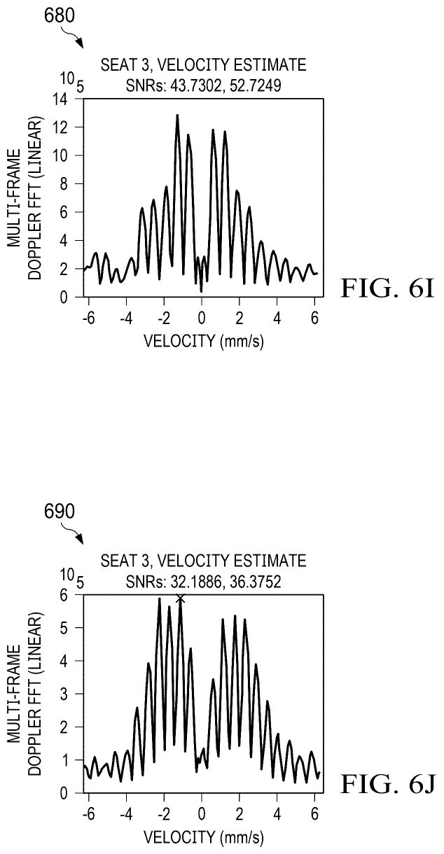

The classification model 540 classifies the environment of the doppler spectrum. In some examples, the classification model 540 classifies the environment of the doppler spectrum as either having or not having a living or animate object. In such examples, the classification model 540 is a machine learning or artificial intelligence model that identifies patterns in the doppler spectrum to classify objects of the environment. This process may allow for clear differentiation between inanimate, shaking objects and a person. In operation, as further illustrated in FIGS. 6A-6J, the doppler spectrum includes a plurality of peaks corresponding to both living and non-living objects. Advantageously, the classification model 540 can classify living objects from the multiple peaks of the doppler spectrum. Advantageously, unlike in the example of FIGS. 2 and 3, the doppler spectrum include both frequency and amplitude data of radar signals. The classification model 540 or, more generally, the object classification circuitry 236 of FIG. 5 classifies an environment has having or not having a living object. Example operations of the object classification circuitry 236 are further illustrated and described in connection with FIGS. 6A-6J, 7, and 8.

FIGS. 2 and 5 are block diagrams of an example implementation of the object classification circuitry 236. The object classification circuitry 236 of FIGS. 2 and 5 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc. Also or alternatively, the object classification circuitry 236 of FIGS. 2 and 5 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIGS. 2 and 5 may, thus, be instantiated at the same or different times. Some or all of the circuitry of FIGS. 2 and 5 may be instantiated, for example, in one or more threads executing concurrently on hardware or in series on hardware. Moreover, in some examples, some or all of the circuitry of FIGS. 2 and 5 may be implemented by microprocessor circuitry executing instructions or FPGA circuitry performing operations to implement one or more virtual machines or containers.

The programmable circuitry configurable to classify objects may be implemented in a device that includes analog frontend circuitry (e.g., a single-chip solution). Alternatively, the programmable circuitry may be implemented as a chip or device that is separate from/external to the analog frontend circuitry. The analog frontend circuitry may be coupled to antennas or launches for transmitting and receiving radar signals. The antennas or launches may be implemented on package (e.g., antenna-on-package) or as components that are external to the analog frontend circuitry.

FIG. 6A is a plot 600 of example operations of the object classification circuitry 236 of FIG. 5 during a condition where a car seat is shaking in the vehicle 100. In the example of FIG. 6A, the plot 600 illustrates a 1D doppler spectrum of velocities of voxels in the zone 120 across the frames of the range data array 232. Unlike the frequency spectrums of FIGS. 4A-4D, the doppler spectrum of the plot 600 has multiple substantial peaks, which produce large SNRs.

FIG. 6B is a plot 610 of example operations of the object classification circuitry 236 of FIG. 5 during a condition where a water bottle is shaking in the vehicle 100. In the example of FIG. 6B, the plot 610 illustrates a 1D doppler spectrum of velocities of voxels in the zone 120 across the frames of the range data array 232. Unlike the frequency spectrums of FIGS. 4A-4D, the doppler spectrum of the plot 610 has multiple substantial peaks, which produce large SNRs. Similar to FIG. 6A, the plot 610 has peaks with large SNRs for inanimate objects.

FIG. 6C is a plot 620 of example operations of the object classification circuitry 236 of FIG. 5 during a condition where a fan is rotating. In the example of FIG. 6C, the plot 620 illustrates a 1D doppler spectrum of velocities of voxels in the environment surrounding the fan across the frames of the range data array 232. Unlike the frequency spectrums of FIGS. 4A-4D, the doppler spectrum of the plot 620 has multiple substantial peaks, which produce large SNRs. Similar to FIGS. 6A and 6B, the plot 620 has peaks with large SNRs for inanimate objects.

FIG. 6D is a plot 630 of example operations of the object classification circuitry 236 of FIG. 5 during a condition where a toy is in motion. In the example of FIG. 6D, the plot 630 illustrates a 1D doppler spectrum of velocities of voxels in the environment surrounding the fan across the frames of the range data array 232. Unlike the frequency spectrums of FIGS. 4A-4D, the doppler spectrum of the plot 630 has multiple substantial peaks, which produce large SNRs. Similar to FIGS. 6A, 6B, and 6C, the plot 630 has peaks with large SNRs for inanimate objects.

FIG. 6E is a plot 640 of example operations of the object classification circuitry 236 of FIG. 5 during a condition where an identification badge is swinging. In the example of FIG. 6E, the plot 640 illustrates a 1D doppler spectrum of velocities of voxels in the environment surrounding the swinging identification badge across the frames of the range data array 232. Unlike the frequency spectrums of FIGS. 4A-4D, the doppler spectrum of the plot 640 has multiple substantial peaks, which produce large SNRs. Similar to FIGS. 6A, 6B, 6C, and 6D, the plot 640 has peaks with large SNRs for inanimate objects.

FIG. 6F is a plot 650 of example operations of the object classification circuitry 236 of FIG. 5 during a condition where an adult is in the vehicle 100. In the example of FIG. 6F, the plot 650 illustrates a 1D doppler spectrum of velocities of voxels in the zone 120 across the frames of the range data array 232. Unlike the frequency spectrums of FIGS. 4A-4D, the doppler spectrum of the plot 650 has multiple substantial peaks, which produce large SNRs. Unlike the doppler spectrums of FIGS. 6A, 6B, 6C, 6D, and 6E, the plot 650 has additional peaks with large SNRs spread out in relatively small velocity increments. For example, in FIG. 6F, the plot 650 has local peaks approximately every one millimeter per second between a range of plus/minus one millimeters per second and four millimeters per second. Advantageously, the peaks of the plot 650 correspond to the adult in the zone 120 of the vehicle 100.

FIG. 6G is a plot 660 of example operations of the object classification circuitry 236 of FIG. 5 during a condition where a baby is facing away from the radar sensor 130 in the vehicle 100. The baby's breathing signature is present in all three rear seats of vehicle 100 because of multipath returns and the limitations in angular resolution. In the example of FIG. 6G, the plot 660 illustrates a 1D doppler spectrum of velocities of voxels in the zone 120 across the frames of the range data array 232. Unlike the frequency spectrums of FIGS. 4A-4D, the doppler spectrum of the plot 660 has multiple substantial peaks, which produce large SNRs. Unlike the doppler spectrums of FIGS. 6A, 6B, 6C, 6D, and 6E, the plot 660 has additional peaks with large SNRs spread out in relatively small velocity increments. For example, in FIG. 6G, the plot 660 has local peaks approximately every one-half millimeter per second between a range of plus/minus zero millimeters per second and two millimeters per second. Advantageously, the peaks of the plot 660 correspond to the baby in the zone 120 of the vehicle 100.

FIG. 6H is a plot 670 of example operations of the object classification circuitry 236 of FIG. 5 during a condition where a baby is in a footwell of the zone 120 in the vehicle 100. In the example of FIG. 6H, the plot 670 illustrates a 1D doppler spectrum of velocities of voxels in the zone 120 across the frames of the range data array 232. Unlike the frequency spectrums of FIGS. 4A-4D, the doppler spectrum of the plot 670 has multiple substantial peaks, which produce large SNRs. Unlike the doppler spectrums of FIGS. 6A, 6B, 6C, 6D, and 6E, the plot 670 has additional peaks with large SNRs spread out in relatively small velocity increments. For example, in FIG. 6H, the plot 670 has local peaks approximately every one-half millimeter per second between a range of plus/minus zero millimeters per second and two millimeters per second. Advantageously, the peaks of the plot 670 correspond to the baby in the zone 120 of the vehicle 100.

FIG. 6I is a plot 680 of example operations of the object classification circuitry 236 of FIG. 5 during a condition where a baby is facing away from the radar sensor 130 in the vehicle 100. In the example of FIG. 6I, the plot 680 illustrates a 1D doppler spectrum of velocities of voxels in the zone 120 across the frames of the range data array 232. Unlike the frequency spectrums of FIGS. 4A-4D, the doppler spectrum of the plot 680 has multiple substantial peaks, which produce large SNRs. Unlike the doppler spectrums of FIGS. 6A, 6B, 6C, 6D, and 6E, the plot 680 has additional peaks with large SNRs spread out in relatively small velocity increments. For example, in FIG. 6I, the plot 680 has local peaks approximately every one-half millimeter per second between a range of plus/minus zero millimeters per second and two millimeters per second. Advantageously, the peaks of the plot 680 correspond to the baby in the zone 120 of the vehicle 100.

FIG. 6J is a plot 690 of example operations of the object classification circuitry 236 of FIG. 5 during a condition where a baby is in the vehicle 100 without a car seat. In the example of FIG. 6J, the plot 690 illustrates a 1D doppler spectrum of velocities of voxels in the zone 120 across the frames of the range data array 232. Unlike the frequency spectrums of FIGS. 4A-4D, the doppler spectrum of the plot 690 has multiple substantial peaks, which produce large SNRs. Unlike the doppler spectrums of FIGS. 6A, 6B, 6C, 6D, and 6E, the plot 690 has additional peaks with large SNRs spread out in relatively small velocity increments. For example, in FIG. 6J, the plot 690 has local peaks approximately every one-half millimeter per second between a range of plus/minus zero millimeters per second and two millimeters per second. Advantageously, the peaks of the plot 690 correspond to the baby in the zone 120 of the vehicle 100.

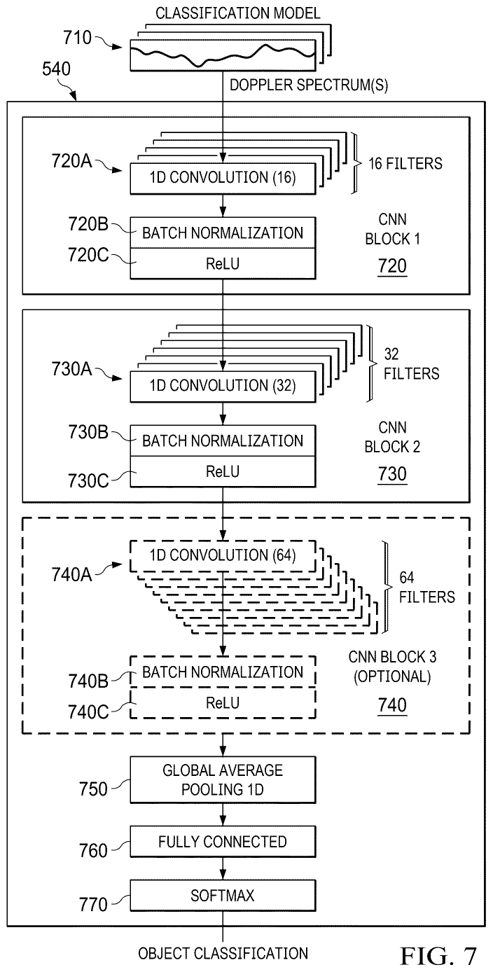

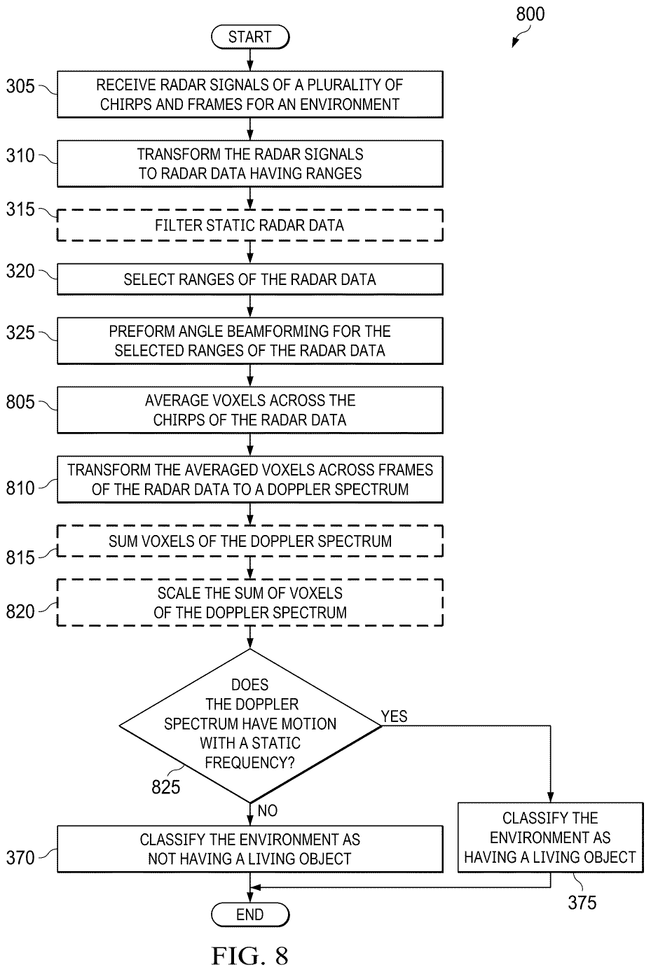

Advantageously, the classification model 540 of FIG. 5 differentiates between the doppler spectrums of FIGS. 6A-6J. For example, the classification model 540 identifies a living object in an environment responsive to patterns in the doppler spectrums of FIGS. 6F-6J. Also, the classification model 540 identifies objects in the environment as inanimate or non-living objects responsive to the pattern in the doppler spectrums of FIGS. 6A-6E. Example operations of the classification model 540 are further illustrated and described in connection with FIGS. 7 and 8.

FIG. 7 is a block diagram of the classification model 540 of FIG. 5, which receives a doppler spectrum 710 as an input. The example classification model 540 of FIG. 7 includes a first neural network (NN) layer 720, a second NN layer 730, a third NN layer 740, pooling circuitry 750, connection layer 760, and softmax circuitry 770. The classification model 540 produces an object classification responsive to the doppler spectrum 710. Although in the example of FIG. 7, the classification model 540 is a neural network, the classification model 540 may be implemented using a different type of machine learning or artificial intelligence model.

The NN layer 720 receives the doppler spectrum 710. In the example of FIG. 7, the NN layer 720 includes convolution filters 720A, normalization logic 720B, and a rectified linear unit (ReLU) 720C. The NN layer 730 includes convolution filters 730A, normalization logic 730B, and a ReLU 730C. The NN layer 740 includes convolution filters 740A, normalization logic 740B, and a ReLU 740C. Although in the example of FIG. 7, the classification model 540 is a neural network having multiple layers, the classification model 540 may be implemented using a different number of layers.

In example operations, the convolution filters 720A, 730A, 740A identify features in the doppler spectrum 710. The convolutional filters 720A, 730A, 740A produce a series of outputs representing different features in the doppler spectrum 710. As the doppler spectrum 710 filters through the layers 720, 730, 740, the convolutional filters 720A, 730A, 740A produce an increasing number of outputs to represent a wider range of features. For example, outputs of the convolutional filters 720A represent whether the doppler spectrum 710 is increasing or decreasing, while outputs of the convolutional filters 740A represent the slope of the doppler spectrum 710.

The normalization logic 720B, 730B, 740B (also referred to as batch normalization logic) uses characteristics of the outputs of the convolutional filters 720A, 730A, 740A to standardize values. In some examples, the normalization logic 720B, 730B, 740B determine a mean and variance of the outputs of the convolutional filters 720A, 730A, 740A. In such examples, the normalization logic 720B, 730B, 740B normalize the outputs of the convolutional filters 720A, 730A, 740A using the mean and variance. The normalization logic 720B, 730B, 740B provide the normalized data to the ReLU 720C, 730C, 740C.

The ReLU 720C, 730C, 740C is an activation function that introduces non-linear considerations to detecting relationships between data. In some examples, the ReLU 720C, 730C, 740C is a piece wise function that sets all negative values to zero. The ReLU 720C, 730C, 740C applies the activation function to the normalized data from the normalization logic 720B, 730B, 740B. In some examples, the filters in NN layers 720, 730, and 740 have a filter size of five and a stride of four. The filter size of five allows for detection of longer patterns such as peaks. The stride of four can enable a final sequence length of two after the last 1D convolution, one for each side of the doppler spectrum.

The pooling circuitry 750 reduces dimensions of feature maps at the output of the NN layers 720, 730, 740 by combining regions of data. In some examples, the pooling circuitry 750 uses a sliding window to average portions of the feature maps from the NN layers 720, 730, 740. In such examples, the averaged feature maps continues to represent significant features of the doppler spectrum 710 using a reduced data set. The pooling circuitry 750 may be configurable to apply global average pooling to average features from both sides of the doppler spectrum.

The connection layer 760 is considered a dense layer having neuron(s) that are coupled to all neurons associated with the feature map of the pooling circuitry 750. The connection layer 760 implements a function that logically combines the averaged feature map to produce an output score. In some examples, the output score from the connection layer 760 represents the classification of a living object in the doppler spectrum 710. The connection layer 760 can map features to class probabilities for various classes of objects.

The softmax circuitry 770 produces class probabilities using the output score of the connection layer 760. In some examples, the softmax circuitry 770 produces a first probability that the doppler spectrum 710 has motion associated with a living object and a second probability that the doppler spectrum 710 does not have motion associated with a living object. In operation, the softmax circuitry 770 produces the object classification based on the probabilities. For example, if the softmax circuitry 770 determines that the doppler spectrum 710 is more likely to have motion associated with a living object, the classification model 540 classifies the environment as having a living object. Example operations of the classification model 540 or, more generally, the object classification circuitry 236 are further illustrated and described in connection with FIG. 8.

FIG. 8 is a flowchart representative of example machine-readable instructions or example operations 800 that may be at least one of executed, instantiated, or performed using an example implementation of the object classification circuitry 236 of FIGS. 2 and 5 or, more generally, the radar system 200 of FIG. 2 in the 100 vehicle of FIG. 1. The example operations 800 begin with Blocks 305, 310, 315, 320, 325. Control proceeds from Block 325 to Block 805, at which the chirp averaging circuitry 248 averages voxels across chirps of the radar data. In example operation, the chirp averaging circuitry 248 averages the radar data of the voxels across different chirps of each of the frames. In some examples, the chirp averaging circuitry 248 averages the radar data of each voxel across each frame of the chirp. The chirp averaging circuitry 248 produces radar data for the voxels (R, θ) across different frames (F).

The doppler FFT circuitry 510 transforms the averaged voxels across frames of the radar data to a doppler spectrum. (Block 810). In example operation, the doppler FFT circuitry 510 performs a doppler FFT on the radar data of the voxels across the different frames (F). The doppler FFT circuitry 510 produces doppler spectrums for the voxels (R, θ). The doppler FFT circuitry 510 produces a doppler spectrum for each voxel.

In some examples, as illustrated by the dashed outline, the summation circuitry 520 sums voxels of the doppler spectrum. (Block 815). In example operation, the summation circuitry 520 combines the doppler spectrums across the voxels. In some examples, the summation circuitry 520 produces a one-dimensional (1D) doppler spectrum representing the different velocities of objects across the frames of the range data array 232. In such examples, the 1D doppler spectrum is a function of both magnitude and phase of vital signs.

Advantageously, unlike the frequency spectrums of FIGS. 2 and 3, the doppler spectrum captures both magnitude and phase of motion in the received signals.

In some examples, as illustrated by the dashed outline, the scaling circuitry 530 scales the sum of voxels of the doppler spectrum. (Block 820). In example operation, the scaling circuitry 530 scales the doppler spectrum. In some examples, the scaling circuitry 530 reduces complexity by decreasing the data size of the doppler values.

The classification model 540 determines if the doppler spectrum has motion with a static frequency. (Block 825). In example operation, the classification model 540 classifies the environment of the doppler spectrum. In some examples, the classification model 540 classifies the environment of the doppler spectrum as either having or not having a pattern associated with a living or animate object. In such examples, the classification model 540 is a machine learning or artificial intelligence model that uses the doppler spectrum to classify objects of the environment. In operation, as further illustrated in FIGS. 6A-6J, the doppler spectrum includes a plurality of peaks corresponding to both living and non-living objects. Advantageously, the classification model 540 can classify living objects from the multiple peaks of the doppler spectrum. The classification model 540 or, more generally, the object classification circuitry 236 of FIG. 5 classifies an environment has having or not having a living object.

If the classification model 540 determines the doppler spectrum does not have motion with a static frequency (e.g., Block 825 returns a result of NO), the classification model 540 classifies the environment as not have a living object. (Block 370). Unlike the operations of block 370 of FIG. 3, the classification model 540 may produce classification(s) corresponding to the radar signals of Block 305. For example, the softmax circuitry 770 may produce a first likelihood of a living object in the doppler spectrum 710 and a second likelihood that there is no living object in the doppler spectrum 710. In such examples, if the second likelihood is greater than the first likelihood, the classification model 540 classifies an environment as not having a living object.

If the classification model 540 determines the doppler spectrum does have motion with a static frequency (e.g., Block 825 returns a result of YES), the classification model 540 classifies the environment as having a living object. (Block 375). For example, the softmax circuitry 770 produces a first likelihood of a living object in the doppler spectrum 710 and a second likelihood that there is no living object in the doppler spectrum 710. In such examples, if the first likelihood is greater than the second likelihood, the classification model 540 classifies an environment as having a living object.

Control proceeds to end. Although example methods are described with reference to the flowchart illustrated in FIG. 8, many other methods of implementing the object classification circuitry 236 of FIGS. 2 and 5 or, more generally, the radar system 200 of FIG. 2 may alternatively be used in this description. For example, the order of execution of the blocks may be changed, and/or some of the blocks described may be changed, eliminated, or combined. Similarly, additional operations may be included in the manufacturing process before, in between, or after the blocks shown in the illustrated examples.

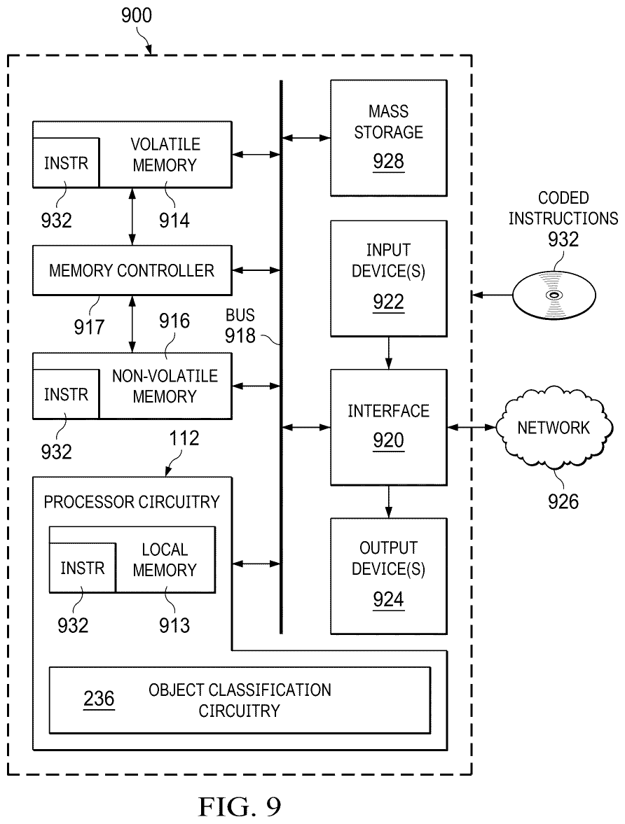

FIG. 9 is a block diagram of an example programmable circuitry platform 900 structured to one or a combination of execute or instantiate one or more of the example machine-readable instructions or the example operations of FIGS. 3 and 8 to implement the object classification circuitry 236 of FIGS. 2 and 5. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, or microcontrollers from any desired family or manufacturer. The programmable circuitry 912 may be implemented by one or more semiconductor based (e.g., silicon based) devices. In this example, the programmable circuitry 912 (also referred to as processing circuitry) implements the object classification circuitry 236 of FIGS. 2 and 5.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 916 may be implemented by one or a combination of flash memory or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter one of or a combination of data or commands into the programmable circuitry 912. The input device(s) 922 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 924 are also connected to the interface circuitry 920 of the illustrated example. The output device(s) 924 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 920 of the illustrated example, thus, includes one of or a combination of a graphics driver card, a graphics driver chip, or graphics processor circuitry such as a GPU.

The interface circuitry 920 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store one or more of firmware, software, or data. Examples of such mass storage discs or devices 928 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 932, which may be implemented by the machine-readable instructions of FIGS. 3 and 8, may be stored in one of or a combination of the mass storage device 928, in the volatile memory 914, in the non-volatile memory 916, or on at least one non-transitory computer readable storage medium such as a CD or DVD which may be removable.

While an example manner of implementing the object classification circuitry 236 of FIG. 1 is illustrated in FIGS. 2 and 5, one or more of the elements, processes, or devices illustrated in FIGS. 2 and 5 may be combined, divided, re-arranged, omitted, eliminated, or implemented in any other way. Further, the multi-range selection circuitry 240, the multi-angle beamforming circuitry 244, the chirp averaging circuitry 248, the phase extraction circuitry 252, the phase difference circuitry 256, the phase FFT circuitry 260, the averaging circuitry 264, the peak selection circuitry 268, the noise voxel selection circuitry 272, the threshold detection circuitry 276, the doppler FFT circuitry 510, the summation circuitry 520, the scaling circuitry 530, the classification model 540, or, more generally, the example object classification circuitry 236 of FIGS. 2 and 5, may be implemented by hardware alone or by hardware in combination with software and firmware. Thus, for example, any of the multi-range selection circuitry 240, the multi-angle beamforming circuitry 244, the chirp averaging circuitry 248, the phase extraction circuitry 252, the phase difference circuitry 256, the phase FFT circuitry 260, the averaging circuitry 264, the peak selection circuitry 268, the noise voxel selection circuitry 272, the threshold detection circuitry 276, the doppler FFT circuitry 510, the summation circuitry 520, the scaling circuitry 530, the classification model 540, or, more generally, the example object classification circuitry 236, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example object classification circuitry 236 of FIGS. 2 and 5 may include one or more elements, processes, or devices in addition to, or instead of, those illustrated in FIGS. 2 and 5, or may include more than one of any or all of the illustrated elements, processes and devices.

Flowchart(s) representative of example machine-readable instructions, which may be executed by programmable circuitry to at least one of implement or instantiate the object classification circuitry 236 of FIGS. 2 and 5 or representative of example operations which may be performed by programmable circuitry to at least one of implement or instantiate the object classification circuitry 236 of FIGS. 2 and 5, are shown in FIGS. 3 and 8. The machine-readable instructions may be one or more executable programs or portion(s) of one or more executable programs for execution by programmable circuitry such as the programmable circuitry 912 shown in the example processor platform 900. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3 and 8, many other methods of implementing the example object classification circuitry 236 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts explained above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3 and 8 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” may be understood to include (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry may be understood as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. A device comprising:
a memory configurable to store radar data across a frame of a plurality of chirps; and
processing circuitry coupled to the memory and configurable to:
average the radar data across the frame;
generate Doppler spectrums for voxels by applying a transform function to the averaged data; and
detect a breathing frequency of an object using the Doppler spectrums.

2. The device of claim 1, wherein the breathing frequency is a pattern of the Doppler spectrums and is indicative of a breathing object or a non-breathing object.

3. The device of claim 1,
wherein the transform function is a second transform function, and
wherein the processing circuitry is configurable to:
determine complex signals of the radar data as a function of range for the frame by applying a first transform function to the radar data;
average the complex signals across the plurality of chirps; and
apply the second transform function to the average of the complex signals.

4. The device of claim 1,
wherein the transform function is a second transform function, and
wherein the processing circuitry is configurable to:
determine magnitudes of the radar data as a function of range for the frame by applying a first transform function to the radar data;
average the magnitudes across the plurality of chirps; and
apply the second transform function to the average of the magnitudes.

5. The device of claim 1, wherein the Doppler spectrums are first Doppler spectrums, and wherein the processing circuitry is configurable to:
generate a second Doppler spectrum by summing across a dimension of the first Doppler spectrums; and
detect the object by applying a neural network to the second Doppler spectrum.

6. The device of claim 5,
wherein the first Doppler spectrums include a multi-dimensional Doppler spectrum,
wherein the second Doppler spectrum is a one-dimensional Doppler spectrum, and
wherein the processing circuitry is configurable to:
generate the one-dimensional Doppler spectrum by summing across the dimension of the multi-dimensional Doppler spectrum; and
detect the object by applying the one-dimensional Doppler spectrum to the neural network.

7. The device of claim 1, further comprising an analog frontend circuit coupled to the memory and configurable to convert radar signals into the radar data.

8. The device of claim 7, further comprising one or more antennas coupled to the analog frontend circuit and configurable to receive the radar signals.

9. The device of claim 1, wherein the transform function is a first transform function; and wherein the processing circuitry is configurable to:
generate frequency and amplitude data for the voxels by applying a second transform function to the radar data;
determine a signal strength at a voxel having a maximum amplitude across the voxels of the radar data; and
classifying an object using the signal strength.

10. The device of claim 9, wherein the signal strength is a signal-to-noise ratio (SNR) of the maximum amplitude to an average amplitude at frequencies near a frequency corresponding to the maximum amplitude, the average amplitude being an average across the voxels of the radar data.

11. A system comprising:
a receiver configurable to receive radar signals of a frame having a plurality of chirps; and
processing circuitry coupled to the receiver and configurable to:
average radar data across the frame, the radar data is representative of the radar signals;
generate Doppler data for ranges and angles using a transform function and the averaged data; and
classifying an object using the Doppler data.

12. The system of claim 11, wherein a pattern of the Doppler data, the pattern indicative of the object being a breathing object.

13. The system of claim 11, wherein the transform function is a second transform function, and wherein the processing circuitry is configurable to:
determine complex signals of the radar data as a function of range for the frame by applying a first transform function to the radar data;
average the complex signals across the plurality of chirps; and
apply the second transform function to the average of the complex signals.

14. The system of claim 11,
wherein the transform function is a second transform function, and
wherein the processing circuitry is configurable to:
determine magnitudes of the radar data as a function of range for the frame by applying a first transform function to the radar data;
average the magnitudes across the plurality of chirps; and
apply the second transform function to the average of the magnitudes.

15. The system of claim 11, wherein the Doppler data is first Doppler data, and wherein the processing circuitry is configurable to:
generate second Doppler data by summing across a dimension of the first Doppler data; and
detect the object by applying a neural network to the second Doppler data.

16. The system of claim 15,
wherein the first Doppler data includes multi-dimensional Doppler data,
wherein the second Doppler data is a one-dimensional Doppler data, and
wherein the processing circuitry is configurable to:
generate the one-dimensional Doppler data by summing across the dimension of the multi-dimensional Doppler data; and
detect the object by applying the one-dimensional Doppler data to the neural network.

17. The system of claim 11, wherein the transform function is a first transform function; and wherein the processing circuitry is configurable to:
generate frequency and amplitude data for the ranges and the angles by applying a second transform function to the radar data;
determine a signal-to-noise ratio (SNR) at a voxel having a maximum amplitude across the voxels of the radar data, the SNR based on the maximum amplitude to an average amplitude at frequencies near a frequency corresponding to the maximum amplitude, the average amplitude being an average across the voxels of the radar data; and
detect an object having periodic motion using the SNR.

18. A method comprising:
obtaining radar data of a plurality of chirps of a frame, the radar data representing an environment;
averaging the radar data across the frame;
generating Doppler data for voxels by applying a transform function to the averaged data;
detecting an object in the environment; and
classifying the object as having periodic motion using the Doppler data.

19. The method of claim 18, wherein the transform function is a second transform function, and wherein the method is further comprising:
determining complex signals of the radar data as a function of range for the frame by applying a first transform function to the radar data;
averaging the complex signals across the plurality of chirps; and
applying the second transform function to the average of the complex signals.

20. The method of claim 18, wherein the Doppler data is first Doppler data, and wherein the method is further comprising:
generating second Doppler data by summing across a dimension of the first Doppler data; and
classifying the object as one of living or non-living by applying a neural network to the second Doppler data.

21. The method of claim 18, wherein the transform function is a first transform function; and wherein the method is further comprising:
generating frequency and amplitude data for the voxels by applying a second transform function to the radar data;
determining a signal strength at a voxel having a maximum amplitude by averaging amplitudes, the signal strength being a ratio of the maximum amplitude to an average amplitude at frequencies near a frequency corresponding to the maximum amplitude, the average amplitude being an average across the voxels of the radar data; and
classifying the object as living or not living using the signal strength.
